(19) United States
(12) Patent Application Publication
(10) Pub. No.: US 2022/0148065 A1
(43) Pub. Date: May 12, 2022

(54) AUTOMATIC RECOMMENDATION OF FEATURE UPGRADES IN A TEST AND MEASUREMENT INSTRUMENT

(71) Applicant: Tektronix, Inc., Beaverton, OR (US)

(72) Inventor: Joshua J. O'Brien, Aloha, OR (US)

(73) Assignee: Tektronix, Inc., Beaverton, OR (US)

(21) Appl. No.: 17/515,198

(22) Filed: Oct. 29, 2021

Related U.S. Application Data
(60) Provisional application No. 63/111,569, filed on Nov. 9, 2020.

(51) Int. Cl. G06Q 30/06; G06F 11/273; G06F 8/65

(52) U.S. Cl. CPC G06Q 30/0631; G06F 8/65; G06F 11/2733

(57) ABSTRACT

A test and measurement instrument includes a system and/or method to generate a recommendation of a feature upgrade to the instrument. Such a method may include receiving a request by a user to perform an action on the instrument and performing the requested action by the instrument to generate first results. Then the instrument modifies an instrument parameter to one that is not presently available to the user, and performs the requested action again with the modified parameter to generate second results. After both results are generated, the instrument compares the first results to the second results and informs the user when the second results differ from the first results. Informing the user may include instructions for upgrading the instrument to include the modified parameter.

### CROSS-REFERENCE TO RELATED APPLICATIONS

This disclosure claims benefit of U.S. Provisional Application No. 63/111,569, titled “AUTOMATIC RECOMMENDATION OF FEATURE UPGRADES IN A TEST AND MEASUREMENT INSTRUMENT,” filed on Nov. 9, 2020, the disclosure of which is incorporated herein by reference in its entirety.

### TECHNICAL FIELD

This disclosure relates to test and measurement instruments, and more particularly to test and measurement instruments having features that are field-upgradable.

### BACKGROUND

Test and measurement instruments commonly include features in both hardware and software that can be enabled by the customer with an additional license purchase. In other words, a base license may not include some of the more advanced features available to those who have purchased a more feature-rich license. Many customers choose particular instruments because of possibility of upgrading the instrument, since the provision of an upgrade path enables future-proofing of the purchase. Despite the availability of upgrades, however, very few customers actually upgrade purchase these upgrades, even though such upgrades would require nothing more than purchasing a new, higher grade, license, and perhaps entering in a new license key into the instrument. Time-bounded demonstration licenses do not fully solve the problem. For one reason, a new user may start using the instrument after the time-bounded license has already lapsed, and the new user wouldn't know to search for a temporary license. Further, in some cases, time-bounded licenses are single use licenses, and thus a second user would not be able to reuse the demonstration license. In general, a significant reason that a customer may not upgrade the instrument is because the customer is unaware that the instrument can be upgraded.

Embodiments of this disclosure address these and other issues in the state of the art.

### BRIEF DESCRIPTION OF THE DRAWINGS

FIG. 1 is a block diagram of a test and measurement instrument that includes an upgrade recommendation feature according to embodiments of the disclosure.

FIG. 2 is a flow diagram including example operations that can be executed to invoke an upgrade recommendation feature in a measurement device according to embodiments of the disclosure.

FIG. 3A is a representation of a display screen of an instrument having an upgrade recommendation feature in a first state according to embodiments of the disclosure.

FIG. 3B is a representation of a display screen of an instrument having an upgrade recommendation feature in a second state according to embodiments of the disclosure.

FIG. 4 is a representation of a display screen of an instrument having another upgrade recommendation feature in a second state according to embodiments of the disclosure.

### DETAILED DESCRIPTION

According to embodiments of the disclosure, a test and measurement instrument includes an upgrade recommendation facility feature. In some embodiments, the upgrade recommendation feature automatically informs the user that an upgrade is or may be available. The recommendation may be made periodically, or the recommendation may be made based on the actions of the user. The recommendations may be based on particular tests run by the user, or based on test results. In some embodiments the recommendation feature may be turned off or muted for a set or controllable time period. Multiple variations and examples are described below.

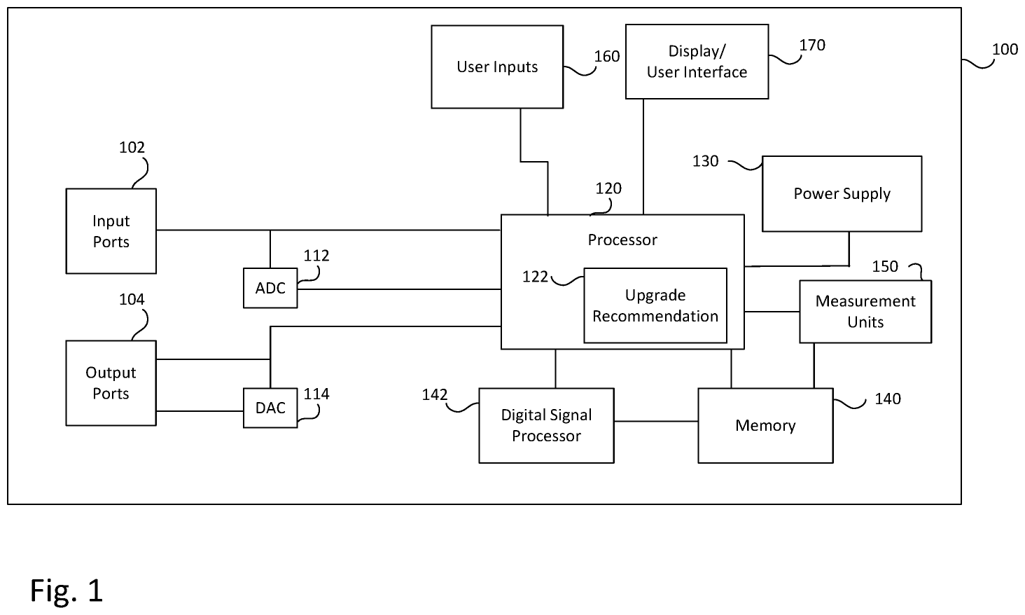

FIG. 1 is a block diagram of a test and measurement instrument 100 that includes an upgrade recommendation feature according to embodiments of the disclosure. The test and measurement instrument 100 includes one or more input ports 102 and one or more output ports 104 which may be any electrical or optical signaling medium. Ports 102, 104 may include receivers, transmitters, and/or transceivers. Input ports 102 are used to receive signals from an attached device, such as a Device Under Test (DUT), a circuit, a discrete device or set of devices, or other object being tested. Output ports 104 are used to carry generated signals out of the instrument 100 to be applied to a device or a DUT. Examples of output signals include waveforms as well as constant currents and voltages, and may be applied to the device or devices being tested. Each input port 102 may represent a channel of the test and measurement instrument 100. The input ports 102 may be coupled to one or more Analog to Digital Converters (ADCs) 112 to convert an analog signal received at the input ports to a digital signal so that the input signal may be processed in the digital domain by components of the instrument 100. Similarly, the output ports 104 may be coupled to one or more Digital to Analog Converters (DACs) 114 to convert a digital signal to an analog signal for outputting over the output ports 104.

The instrument 100 further includes one or more processors 120 to process the signals and/or waveforms received at the ports 102 from one or more devices under test. Output ports 104 are likewise coupled to the processor 120, or other components within the instrument 100 that generate the appropriate output signals to be sent out of the instrument. Although only one processor 100 is shown in FIG. 1 for ease of illustration, as will be understood by one skilled in the art, multiple processors 120 of varying types may be used in combination, rather than a single processor 120.

The one or more processors 120 may be configured to execute instructions from a memory 140 and may perform any methods and/or associated steps indicated by such instructions, such as making upgrade recommendations according to embodiments of the disclosure. The memory 140 may be implemented as processor cache, random access memory (RAM), read only memory (ROM), solid state memory, hard disk drive(s), or any other memory type. The memory 140 acts as a medium for storing data, computer program products, and other instructions. Although illustrated in FIG. 1 as a single memory, the memory 140 may be implemented in multiple modules or separate memories. Further, many of the components of the measurement instrument 100 may include dedicated memory of their own, which may be accessible by the processor 120.

Embodiments of the invention include an upgrade recommendation feature 122. The upgrade recommendation feature 122 is illustrated in FIG. 1 as being within the processor 120, but this placement is merely meant to convey that the upgrade recommendation feature 122 may operation in conjunction with or is controlled by the processor 120. The recommendation feature 122 may be a stand-alone process, or processor, or may operate in conjunction with other hardware or software within the instrument 100. For example, the recommendation feature 122 may operate in conjunction with a digital signal processor 142, described below. In effect, the upgrade recommendation feature 122 may be implemented in any standard way that other features are implemented in measurement instruments.

The one or more processors 120 may be coupled to or provide the function of one or more measurement units 150. Such measurement units 150 can include any component capable of measuring aspects (e.g., voltage, amperage, amplitude, etc.) of signals received via the input ports 102. The measurement units 150 may retrieve data from or store data to the memory 140.

The instrument 100 includes a power supply 130 to power the components of the instrument.

The test and measurement instrument 100 may include additional hardware and/or processors, such as conditioning circuits, and/or other circuitry to convert or analyze a received signal to a waveform for further analysis. The resulting waveform can then be stored in a memory 140, as well as displayed on a display 170. Also the digital signal processor 142 may perform various operations and analysis on test signals received from the input ports 102, or may generate signals for output through the output ports 104.

User inputs 160 are coupled to the one or more processors 120. The user inputs 160 may include a keyboard, mouse, trackball, touchscreen, and/or any other controls employable by a user to interact with a User Interface on the display 170. The display 170 may be a digital screen, a cathode ray tube based display, or any other monitor to display waveforms, measurements, and other data to a user. While the components of test instrument 100 are depicted as being integrated within test and measurement instrument 100, it will be appreciated by a person of ordinary skill in the art that any of these components can be external to test instrument 100 and can be coupled to test instrument 100 in any conventional manner (e.g., wired and/or wireless communication media and/or mechanisms). For example, in some embodiments, the user inputs 160 and the display 170 may be remote from the test and measurement instrument 100.

Some of the components of the measurement instrument 100 may include restricted access depending on the particular license of a user. For example, some software programs may be limited or may not be installed for lower-level licenses. Common software-upgradable features include trigger capabilities, as well as specialty software applications like analysis packages, compliance tools or decoders. Some of these features may be individually licensed. In such a case, the user pays the license fee to ‘unlock’ the desired feature. Then, after paying the license fee, a license key or other information is provided to the instrument 100. In response, the instrument 100 loads particular software, makes an entry in a particular table, or otherwise allows access to the newly acquired features. In other embodiments several upgrade features may be grouped together and unlocked with a single license upgrade.

Some hardware features in an instrument 100 may be locked as well. For example a base license may give access to only a portion of the memory 140, while a full license gives access to all of the memory 140 on the instrument 100. Access to more memory 140 allows a user to store more incoming test data, or store the test data at a higher resolution than if only a portion of the memory 140 is available. Another hardware feature that may be available under license is bandwidth, which may be controlled by filters or other components of the digital signal processor 142, or by the ADC 112 and DAC 114.

Combination of hardware and software upgrades may allow an oscilloscope embodiment of the instrument 100 to provide, based on the license, various levels of memory depth, bandwidth, trigger capabilities, particular analysis packages, compliance tools, and decoders. For spectrum analyzer embodiments of the instrument 100, attributes controlled by hardware and software licenses include bandwidth and span. Yet other embodiments of the instrument 100 may include other features or attributes that are controlled by license. These are just a few examples, and not an exhaustive list. Embodiments of the invention are operable with any type of instrument that offer features or attributes that may be individually enabled or modified. These features or attributes may be turned on, turned off, enhanced, or even de-enhanced based on a status of license level, identity of the user, time of use, number of uses, or other criteria desired by the manufacturer.

As mentioned above, some customers may not upgrade the measurement device even though an upgrade would seemingly be beneficial to the customer. A first reason that the upgrade rate can be low is lack of customer awareness. Customers become familiar with an instrument during the shopping and initial purchase phase, but may not evaluate the product deeply enough to understand all of the upgrade options or to remember these options months or years later. Furthermore, instrument manufacturers may add potential upgrades after the initial purchase, for example by releasing a software update for the instrument. Instruments are also used by customers who weren't involved in the original purchase process. Test equipment has long lifecycles and equipment is typically shared by or cycles through many users. These newer users are unlikely to be aware of what options are available on a piece of equipment. Another reason the upgrade rate can be low is that customers do not know how an upgrade will change their data or measurement. As an example, a rise time measurement could be limited by an oscilloscope's bandwidth and rise time limitations. Many customers would not be aware of how much the bandwidth limits their rise time. A customer may be trying to measure a rise time that is half of the rated rise time of an oscilloscope, and still see significant measurement error because of the timing mismatch. Another example is a spectrum analyzer with upgradable span. A customer may make a measurement that is limited by the instrument's current, licensed, span even though the hardware may be capable of making a better measurement with a span license upgrade. These original measurements may not include spurs that are just outside of the current span, although they would include the spurs had the span been upgraded by license. In the state of the art, the customer has no way to understand the impact of the scope's risetime or spectrum analyzer's span limitation without enabling the feature. Embodiments of the disclosed technology include detecting when a license upgrade may be useful and available to a customer. The license upgrade may unlock hardware features, software features, or a combination of hardware and software features.

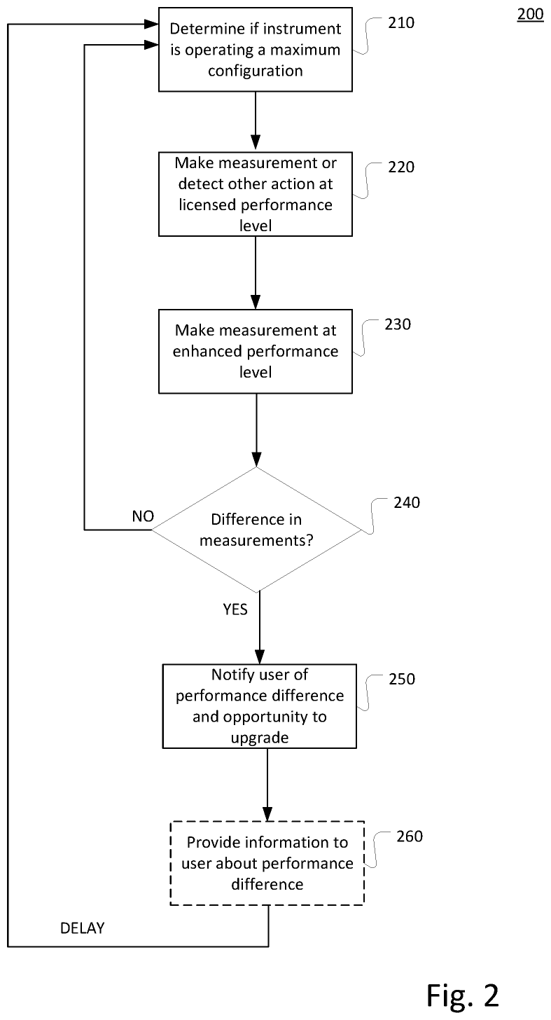

FIG. 2 is a flow 200 including example operations that can be executed to invoke an upgrade recommendation feature in a measurement device according to embodiments of the disclosure. The flow 200 begins at an operation 210 that determines if the instrument, such as the instrument 100 of FIG. 1, is already operating at the maximum configuration. If the instrument is already operating at maximum configuration, then there is no reason to offer an upgrade to a user.

In an operation 220, the user makes a measurement or performs an action on the instrument. Such a measurement may be one related to current, voltage, time, etc. Or a user action may be scrolling through a measurement, or increasing the resolution of a particular displayed waveform. The measurement in operation 220 is made at the licensed performance level. For example, if the instrument is a spectrum analyzer that has a hardware capability of operating at a 160 MHz span, but the present licensed span limit is 40 MHz, then the operation 220 makes the measurement at the licensed span limit of 40 Mhz. Then, in an operation 230, embodiments of the invention also take a measurement at a higher performance level than the presently licensed and configured performance level. The enhanced performance level measurement taken in operation 230 may be the maximum performance level possible to be taken by the instrument 100. In the example above, the maximum performance measurement capable by the instrument is 160 MHz, so the measurement taken in operation 230 is taken at 160 MHz. Or, the enhanced performance level measurement taken in operation 230 may be at a performance level that is above the licensed performance level, but less than the full capabilities of the instrument 100. For example, the enhanced performance level measurement taken in operation 230 may be taken at 60, 80, 100, 120, or 140 MHz. In yet other embodiments, the enhanced performance level measurement taken in operation 230 may be any or all of the possible performance levels between the licensed performance level and the highest performance level that is possible by the instrument 100.

A decision 240 determines whether there is any difference between the measurement taken at the licensed performance level and any of the higher performance levels. If there is no difference in the measurements, the flow 200 exits the decision 240 in the NO direction and the flow returns. In other words, if there is no difference between the licensed performance level and the highest possibility of the instrument 100, then there would be no reason to offer the user an upgrade. In some embodiments, to exit the decision 240 in the YES direction, the measurement difference between the licensed and higher performance measurements must be over a performance threshold, such as 5-10%, or other measure. In such an embodiment, it may be preferable to not interrupt the user if the licensed use of the instrument is already, for example, 99% of the capabilities of the instrument.

In embodiments where the user performed an action in the operation 220, such as scrolling through a waveform, the decision 240 may determine whether the action could have continued had the instrument had a higher performance level. For example, if the user exhausts the present memory depth by scrolling, but the instrument has more memory depth available with an enhanced license, then the decision 240 would also exit in the YES direction.

If there is a performance difference between the licensed performance measurement taken in the operation 220 and a higher performance measurement taken in the operation 230, then the upgrade recommendation feature according to embodiments of the invention may notify the user that there is a performance difference, or appreciable performance difference in an operation 250. The operation 250 may also invite or instruct the user how to make the upgrade, such as by displaying upgrade instructions on the display or UI 170 (FIG. 1). Many examples are provide below.

Further, in some instances, the upgrade recommendation feature on the instrument 100 may also provide specific information to the user about how the performance capabilities of the instrument are better than the present, licensed capabilities of the instrument. In this way, the upgrade recommendation feature provides contextual, relevant, timely, material, and real-life instances of how the user experience of the instrument may be enhanced by upgrading the present license.

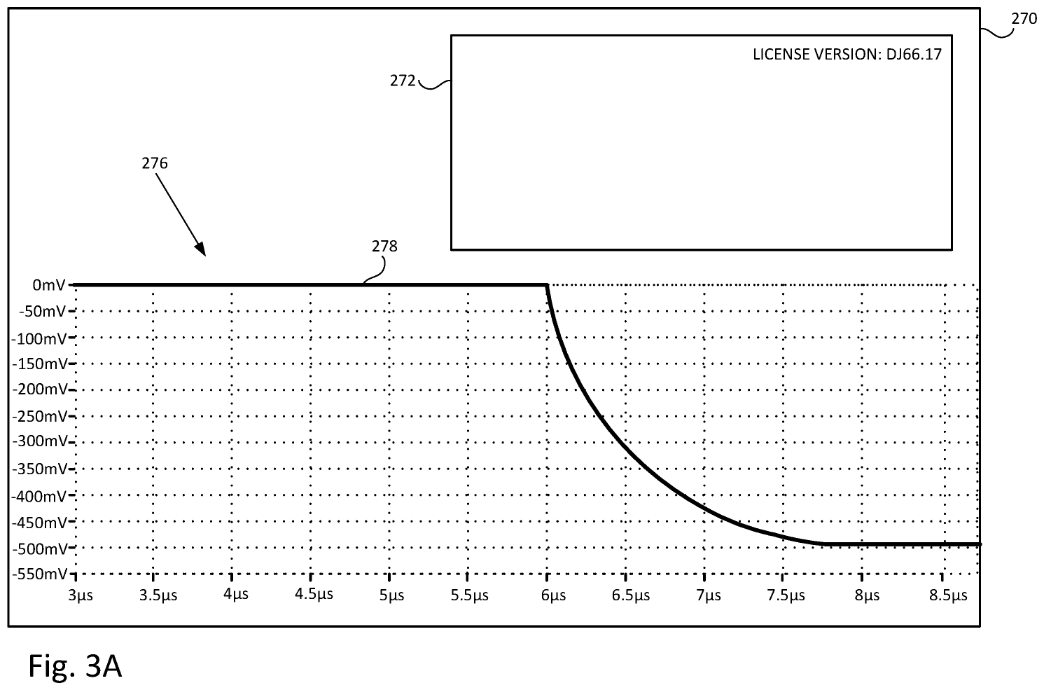

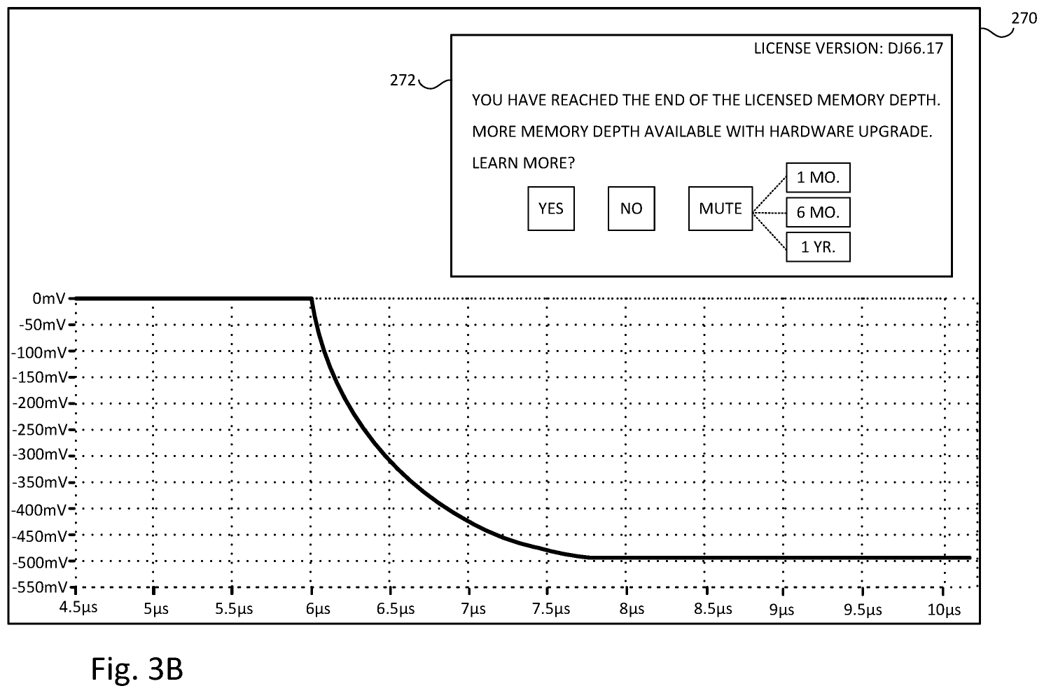

FIG. 3A is a representation of a display screen 270 of an instrument having an upgrade recommendation feature in a first state, while FIG. 3B illustrates the display screen in a second state according to embodiments of the disclosure. In FIG. 3A, a voltage vs time measurement is being made on an instrument 200, which may be an embodiment of the instrument 100 described above. The voltage vs. time measurement is made in a measurement display area 276 of the display 270, and a particular waveform 278 is illustrated.

In this example, assume that the licensed memory depth of the memory in the instrument 140 allows up to 10 μs of captured waveform data to be displayed in the measurement display area (1 million samples at 100 GSa/s), and that a user can scroll through a captured waveform with user controls. Typical instruments may store much more than 10 μs of samples depending on the resolution and memory bit depth. An instrument having 1G of data memory, for example, may store 10 ms of samples at 100 GSa/s. These numbers are merely for illustration purposes.

A license display area 272 of the display screen 270 informs the user of the present license version, or license level, which in the illustrated case is DJ66.17. In the present state of the instrument 200 in FIG. 3A, there is no additional information displayed in the license display area 272 of the display screen 270.

FIG. 3B illustrates the display screen 270 of the instrument 200 when the user has scrolled to the end of the memory depth, i.e., to the end of the stored 10 μs of waveform data. As described above, such an action can trigger the decision 240 (FIG. 2) to alert the user that a hardware or software upgrade is available. Such an alert is illustrated in the license display area 272 of the display screen 270 in FIG. 3A, which informs the user that he or she has reached the end of the licensed memory, and that more memory would be available if the user were to upgrade the license. Note how this alert is generated based on a specific action performed by the user, in this case by scrolling to the end of the waveform.

By making a response to the message shown in the license display area 272 of the display screen 270 of FIG. 3B, the user can indicate that he or she wishes to learn more about the upgrade possibility, or that the user is not interested in any upgrades. The user may also indicate, by pressing one of the time periods displayed, that he or she wishes to not be informed of any potential upgrades for a period of time. The times illustrated in the license display area 272 of FIG. 3B are mere examples, and the actual mute times displayed, as well as how many mute times to display, may be selected based on implementation details.

Some embodiments of the invention may periodically reset a “no” response, so that the instrument 100 may, in fact, remind the user that an upgrade is available, even though the user has indicated that he or she is not interested in upgrading the license. This procedure provides for the fact that, as noted above, sometimes a single instrument may be used by many people, or that a user that had indicated no interest in upgrades has been replaced by another user who may be interested in upgrade possibilities. The instrument may perform this reset based on time, such as every few months or years. Or the reset frequency may be based on number of measurements, for example, every 1000 measurement. Other periods of delay between, for instance, the loopback between operations 260 and 210, or elsewhere in the flow 200 may depend on implementation specifics.

With reference back to FIG. 2, some embodiments of the invention may make the measurement at the enhanced performance level in operation 230 only at times where the instrument was idle, i.e., in the background, or when the instrument is otherwise not fully being utilized.

In some embodiments, the measurement made at the licensed performance level 220 may, in fact, be a software-reduced version of a measurement taken at the full performance level of the instrument. In such a case, the measurements of operations 220 and 230 are actually a single measurement, with the licensed measurement taken in operation 220 being the software-reduced measurement.

In some embodiments, the upgrade recommendation feature detects the possibility of need for an upgrade based on the particular UI configuration, such as based on the measurements selected, or which analysis features the user turned on. This feature detects what kind of differences exist between the license-limited and full-hardware-support acquisitions. In the previous span example, had the user enabled 4 peak markers, and there was a spur with a higher amplitude than one of the marked spurs outside of the 40 MHz span, that would be a significant event, and the upgrade recommendation feature could alert the user of such a testing condition, and that an upgrade to the license would produce a better testing result. In another embodiment, the user could also have a spurious-free dynamic range (SFDR) measurement turned on that would have a significantly change at the wider span compared to the licensed span. Then embodiments of the invention could inform the user that an upgraded license would provide better testing results, and offer the user a path for upgrade.

Another example is an oscilloscope user using cursors to measure a step, have a risetime measurement turned on, or have jitter analysis enabled. In addition to making a signal acquisition at the selected specifications, a separate acquisition with the bandwidth of the instrument set to the full limits of the hardware rather than the licensed limits could look for significant differences in any of these. Embodiments of the invention then inform the user that an upgraded feature, in this case bandwidth, would increase the performance of the measurement.

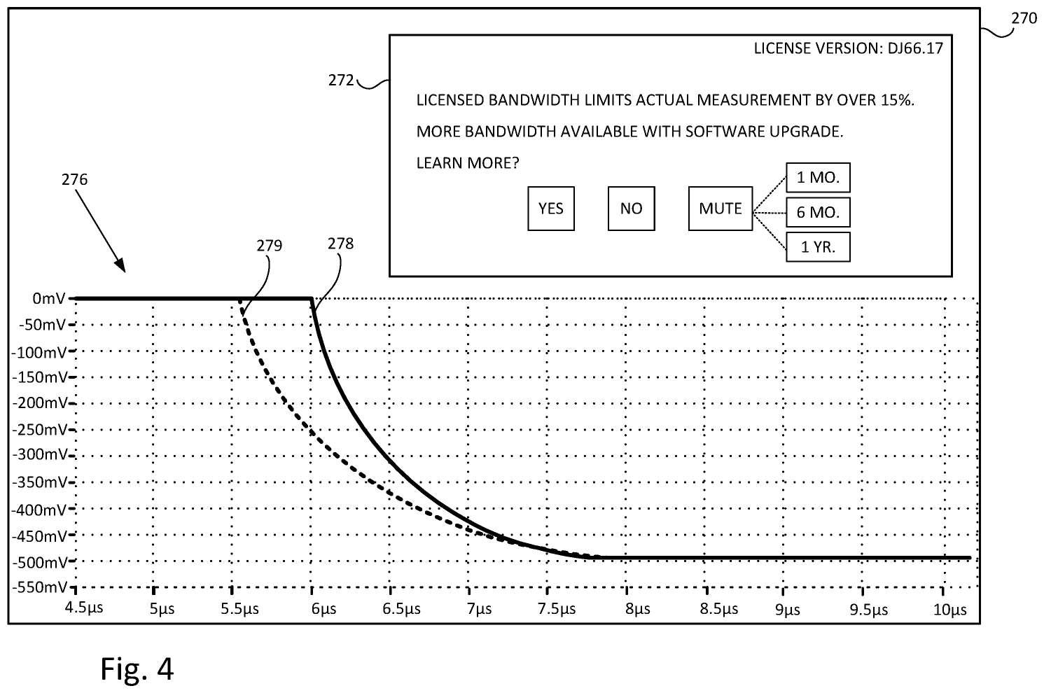

In some embodiments the customer may need more information than simply that a difference exists between the license-limited hardware capabilities and the full hardware capabilities. There are several possible ways to inform the user as an amount of the difference, without giving away the full benefit of the upgrade. For example, in some embodiments the upgrade recommendation feature of the instrument may present the difference in measurements or capabilities as a range of error. For example, as illustrated in FIG. 4, a message in the license display area 272 may be displayed informing the user that a bandwidth limitation is causing a 10-20% error in rise time measurement. Also as illustrated in FIG. 4, the instrument could also display a waveform or measurement at the improved performance level, allowing the user to see the real-time difference that the limit of his or her license is causing. For example, the measurement display area 276 of FIG. 4 displays the waveform 278 using the licensed version of the instrument as well as a waveform 279 that shows the user how the waveform would appear had the full capabilities of the instrument been used. The waveforms 278 and 279 may be presented in different colors or other features to highlight the differences. In some embodiments the waveform 279 would be a displayed waveform, but one that isn't allowed to be saved or have the screen image saved by the user.

Furthermore, many instruments have an auto-set feature. The auto-set feature aims to analyze parameters of the waveform(s) input to the instrument and modify the settings of the instrument to optimize the acquisition and/or display of the waveform(s) on screen. In some embodiments, the upgrade recommendation feature is automatically invoked when the auto-set feature is used. Then, not only does the instrument determine the optimal parameters for the particular input signal, the instrument according to embodiments of the invention further analyzes whether a license upgrade would benefit the user. For instance, the optimal bandwidth and record length could be determined based on the user signal, and then the previously described methods could determine whether the optimal or required bandwidth or record length was greater than what is licensed, and so inform the user.

Although example messages to the user about the ability or desirability to perform an upgrade are given above, the particular messages do not have to take the same form or use the stated language.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the technologies disclosed herein are provided below. A configuration of the technologies may include any one or more, and any combination of, the examples described below.

Example 1 is a method in a measurement instrument having user controls and a user display comprising receiving a request by the user through the user controls to perform an action on the instrument, performing the requested action by the instrument to generate first results, modifying an instrument parameter to a modified parameter that is not presently available to the user, performing the requested action by the instrument with the modified parameter to generate second results, comparing the first results to the second results, and informing the user when the second results differ from the first results.

Example 2 is a method according to example 1, further comprising informing the user only when the second results differ from the first results by at least a difference threshold.

Example 3 is a method according to any of the previous examples, further comprising informing the user of a difference measure between the first results and the second results.

Example 4 is a method according to any of the previous examples, further comprising informing the user the first results and the second results.

Example 5 is a method according to any of the previous examples, further comprising offering the user an ability to acquire the modified parameter for the test instrument.

Example 6 is a method according to any of the previous examples, in which the requested action is performed using a test signal received at the instrument, and in which the same test signal is used to generate the first results and the second results.

Example 7 is a method according to any of the previous examples, in which the instrument parameter is memory capacity or bandwidth.

Example 8 is a method according to any of the previous examples, in which the instrument parameter is a hardware parameter.

Example 9 is a method according to Example 8, in which access to the hardware parameter is controlled by software, and in which the access to the hardware parameter may be modified by software.

Example 10 is a method according to any of the previous examples, in which the instrument parameter is a software parameter selected from the group consisting of trigger capabilities, analysis packages, and decoders.

Example 11 is a test and measurement device comprising user controls, an input structured to accept a signal for testing, and one or more processors. The one or more processors are configured to receive a request by the user through the user controls to perform an action on the instrument, perform the requested action by the instrument to generate first results, modify an instrument parameter to a modified parameter that is not presently available to the user, perform the requested action by the instrument with the modified parameter to generate second results, compare the first results to the second results, and inform the user when the second results differ from the first results.

Example 12 is test and measurement device according to Example 11, in which the one or more processors are further configured to inform the user only when the second results differ from the first results by at least a difference threshold.

Example 13 is a test and measurement device according to any of the previous examples 11-12, in which the one or more processors are further configured to inform the user of a difference measure between the first results and the second results.

Example 14 is a test and measurement device according to any of the previous examples 11-13, in which the one or more processors are further configured to inform the user the first results and the second results.

Example 15 is a test and measurement device according to any of the previous examples 11-14, in which the one or more processors are further configured to offer the user an ability to acquire the modified parameter for the test instrument.

Example 16 is a test and measurement device according to any of the previous examples 11-15, in which the requested action is performed using a test signal received at the test and measurement device, and in which the same test signal is used to generate the first results and the second results.

Example 17 is a test and measurement device according to any of the previous examples 11-16, in which the instrument parameter is memory capacity or bandwidth.

Example 18 is a test and measurement device according to any of the previous examples 11-17, in which the instrument parameter is a hardware parameter.

Example 19 is a test and measurement device according to Example 18, in which access to the hardware parameter is controlled by software, and in which the access to the hardware parameter may be modified by software.

Example 20 is a test and measurement device according to any of the previous examples 11-19 in which the instrument parameter is a software parameter selected from the group consisting of trigger capabilities, analysis packages, and decoders.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

Although specific aspects of the disclosure have been illustrated and described for purposes of illustration, it will be understood that various modifications may be made without departing from the spirit and scope of the disclosure. Accordingly, the disclosure should not be limited except as by the appended claims.

We claim:

1. A method in a measurement instrument having user controls and a user display, the method comprising:
receiving a request by the user through the user controls to perform an action on the instrument;
performing the requested action by the instrument to generate first results;
modifying an instrument parameter to a modified parameter that is not presently available to the user;
performing the requested action by the instrument with the modified parameter to generate second results;
comparing the first results to the second results; and
informing the user when the second results differ from the first results.

2. The method according to claim 1, further comprising informing the user only when the second results differ from the first results by at least a difference threshold.

3. The method according to claim 1, further comprising informing the user of a difference measure between the first results and the second results.

4. The method according to claim 1, further comprising informing the user the first results and the second results.

5. The method according to claim 1, further comprising offering the user an ability to acquire the modified parameter for the test instrument.

6. The method according to claim 1, in which the requested action is performed using a test signal received at the instrument, and in which the same test signal is used to generate the first results and the second results.

7. The method according to claim 1, in which the instrument parameter is memory capacity or bandwidth.

8. The method according to claim 1, in which the instrument parameter is a hardware parameter.

9. The method according to claim 8, in which access to the hardware parameter is controlled by software, and in which the access to the hardware parameter may be modified by software.

10. The method according to claim 1, in which the instrument parameter is a software parameter selected from the group consisting of trigger capabilities, analysis packages, and decoders.

11. A test and measurement device, comprising:
user controls;
an input structured to accept a signal for testing; and
one or more processors configured to:
receive a request by the user through the user controls to perform an action on the instrument,
perform the requested action by the instrument to generate first results,
modify an instrument parameter to a modified parameter that is not presently available to the user,
perform the requested action by the instrument with the modified parameter to generate second results,
compare the first results to the second results, and
inform the user when the second results differ from the first results.

12. The test and measurement device according to claim 11, in which the one or more processors are further configured to inform the user only when the second results differ from the first results by at least a difference threshold.

13. The test and measurement device according to claim 11, in which the one or more processors are further configured to inform the user of a difference measure between the first results and the second results.

14. The test and measurement device according to claim 11, in which the one or more processors are further configured to inform the user the first results and the second results.

15. The test and measurement device according to claim 11, in which the one or more processors are further configured to offer the user an ability to acquire the modified parameter for the test instrument.

16. The test and measurement device according to claim 11, in which the requested action is performed using a test signal received at the test and measurement device, and in which the same test signal is used to generate the first results and the second results.

17. The test and measurement device according to claim 11, in which the instrument parameter is memory capacity or bandwidth.

18. The test and measurement device according to claim 11, in which the instrument parameter is a hardware parameter.

19. The test and measurement device according to claim 18, in which access to the hardware parameter is controlled by software, and in which the access to the hardware parameter may be modified by software.

20. The test and measurement device according to claim 11, in which the instrument parameter is a software parameter selected from the group consisting of trigger capabilities, analysis packages, and decoders.
